(19) United States
(12) Patent Application Publication
(10) Pub. No.: US 2009/0264198 A1
(43) Pub. Date: Oct. 22, 2009

(54) 3D GAME DISPLAY SYSTEM, DISPLAY METHOD, AND DISPLAY PROGRAM

(75) Inventors: Hiroyuki Takahashi, Tokyo (JP); Shugo Takahashi, Tokyo (JP); Haruki Kodera, Tokyo (JP)

Correspondence Address: MAIER & MAIER, PLLC, 1000 DUKE STREET, ALEXANDRIA, VA, 22314, US

(73) Assignee: Camelot Co., Ltd., Tokyo (JP)

(21) Appl. No.: 12/302,408

(22) PCT Filed: May 28, 2007
(86) PCT No.: PCT/JP2007/060842

§ 371 Date: Jun. 24, 2009

(30) Foreign Application Priority Data
May 26, 2006 (JP) 2006-146467

(51) Int. Cl. A63F 13/00

(52) U.S. Cl. 463/32

(57) ABSTRACT

A 3D game display system includes a 3D configuration unit for virtually configuring a 3D space and controlling an object coordinate, a window control unit for controlling displayed windows, a 2D configuration unit for causing a window to two-dimensionally display a 3D space according to the field-of-view range based on the window type, area and shape, a GUI control unit arranged in the window and controlling a GUI for performing display and operations concerning the game, an input interface for performing operations on the windows and the GUI, and an expansion/contraction control unit for changing the area or the shape of the windows according to the operations of the input interface. This enables the display of diversified game contents using multi-windows in a 3D game and maintains a balance between the display of the game content itself and the GUI while maintaining the GUI operability.

### FIELD OF THE INVENTION

The present invention relates to a 3D game display system, a 3D display method and a 3D display program, for displaying the progress of a game program in a two-dimensional screen with players or other objects arranged in a virtual 3D space, for example, when playing with a 3D scene of a sports game such as a golf game, a tennis game or a baseball game, or a 3D scene of a role playing game.

### BACKGROUND ART

Conventionally, television games have been developed in many ways, for example, as home video game dedicated machines, coin-operated arcade game machines and the like, and also as game software which can be run by a general-purpose computer such as a personal computer. Also, with the recent advances in the communications infrastructures, game programs provided through a communication network such as the Internet have become popular as distributed by the so-called online gaming services.

In addition, for playing a television game, a player performs an operation through GUI (Graphical User Interface, for example, refer to Patent Document 1). In the case of a game runnable on a personal computer, a game program is run on an OS (Operating System) as an application which displays a GUI arranged in multiple windows on a display through which the player performs an operation for playing a game.

Meanwhile, in the case of a simulation game such as a golf game, the game is played in a virtually established 3D space as displayed in two-dimensional screen. Particularly, the operability of such a three-dimensional game can be improved when the game scene can be viewed from various angles at the same time. Specifically, in the case of a game runnable on a personal computer, a number of windows can be displayed by the use of multi-window functionality of the OS so that the player can arbitrarily arrange these windows in accordance with his preference. In addition to this, when the player arbitrarily arranges multiple windows in accordance with his preference, he may want to freely set up also the sizes and shapes of these windows in accordance with his preference.

However, as has been discussed above, a GUI is provided in a window of a game for receiving operation as shown in FIG. 6(a). When changing the window only in size and shape, as shown in FIGS. 6(b) to 6(d), the GUI is expanded/contracted and deformed in the same horizontal to vertical ratio as the window. The profile of the GUI is thereby distorted to lose the balance between the display of game content and the GUI, such that the game content may be difficult to see, and the operability of the GUI may be deteriorated.

In order to solve the problem as described above, it is an object of the present invention to provide a 3D game display system, a 3D display method and a 3D display program, for displaying the progress of a game program such as a golf game in a two-dimensional screen with players, balls or other objects arranged in a virtual 3D space, in which game content can be displayed from many directions in multiple windows, and it is possible to maintain the operability of the GUI and the balance between the display of game content and the GUI.
Patent Document 1: Japanese Patent Published Application No. 2004-216165

### DISCLOSURE OF THE INVENTION

In accordance with the present invention, a 3D game display system is provided for displaying the progress of a game program in a two-dimensional screen with objects arranged in a virtual 3D space, and comprises: a 3D configuration unit configured to virtually construct the 3D space, and control the position coordinates of the objects; a window control unit configured to control a window displayed in the screen; a 2D configuration unit configured to two-dimensionally display the 3D space in the window in accordance with the field-of-view range on the basis of the type, area and shape of the window; a user interface control unit configured to control a graphic user interface which is arranged in the window for use in displaying information about the game and inputting operation to the game; an input interface used for performing operation of the graphic user interface; and an expansion/contraction control unit configured to change the window in area or shape on the basis of the operation input through the input interface, wherein the graphic user interface is displayed on the basis of the position and scale in relative coordinates to the base point which is unique to the window; wherein the expansion/contraction control unit calculates the position of the base point and the scale of the relative coordinates in accordance with the shape of the window.

Also, a 3D game display method in accordance with the present invention comprises:

(1) virtually constructing the 3D space, and controlling the position coordinates of the objects;

(2) two-dimensionally displaying the 3D space in the window in accordance with the field-of-view range on the basis of the type, area and shape of the window in the two-dimensional screen by the use of a 2D configuration unit, and controlling a graphic user interface which is arranged in the window for use in displaying information about the game and inputting operation to the game by the use of a user interface control unit; and

(3) receiving operation of the graphic user interface through an input interface, and changing the window in area or shape by the use of an expansion/contraction control unit on the basis of the operation input through the input interface.

Particularly, in the step (2), the graphic user interface is displayed on the basis of the scale determined in accordance with the distance in relative coordinates from the base point which is unique to the window, and in the step (3), the expansion/contraction control unit calculates the position coordinates of the base point in accordance with the shape of the window.

Preferably, in accordance with in the above invention, the base point is displayed in position coordinates at the scale corresponding to the smaller one of the expansion ratios in the vertical and horizontal directions of the window. Also, preferably in accordance with in the above invention, upper and lower limits are set for the ratio of expansion and contraction of the graphic user interface, and the graphic user interface is expanded and/or contracted between the upper and lower limits in accordance with the change of the window in area.

In accordance with the present invention as described above, it is possible to view a virtual 3D space from arbitrary angles in various ways through the multiple windows, rearrange the GUI in the window on the basis of the relative distances and angles as seen from the base points which are displaced in synchronization with the expansion/contraction of the window, and thereby prevent deformation and excessive expansion/contraction due to the expansion/contraction of the window.

Incidentally, the system and method of the present invention as described above can be implemented by running a program written in a predetermined language on a computer. In addition, such a program can be stored in a computer readable medium, so that the program can be easily maintained, transported and installed.

### BRIEF DESCRIPTION OF THE DRAWINGS

FIG. 1 is a block diagram for showing the configuration of a 3D game system in accordance with an embodiment.

FIG. 2 is an explanatory view for showing the configuration of the screen of the 3D game system in accordance with the embodiment.

FIG. 3 is an explanatory view for showing the expansion/contraction process of the window of the 3D game system in accordance with the embodiment.

FIG. 4 is a flow chart for showing the process of displaying the window of the 3D game system in accordance with the embodiment.

FIG. 5 is a perspective view for showing computer readable mediums in accordance with the embodiment.

FIG. 6 is an explanatory view for showing the expansion/contraction process of the window of a 3D game system in accordance with the prior art.

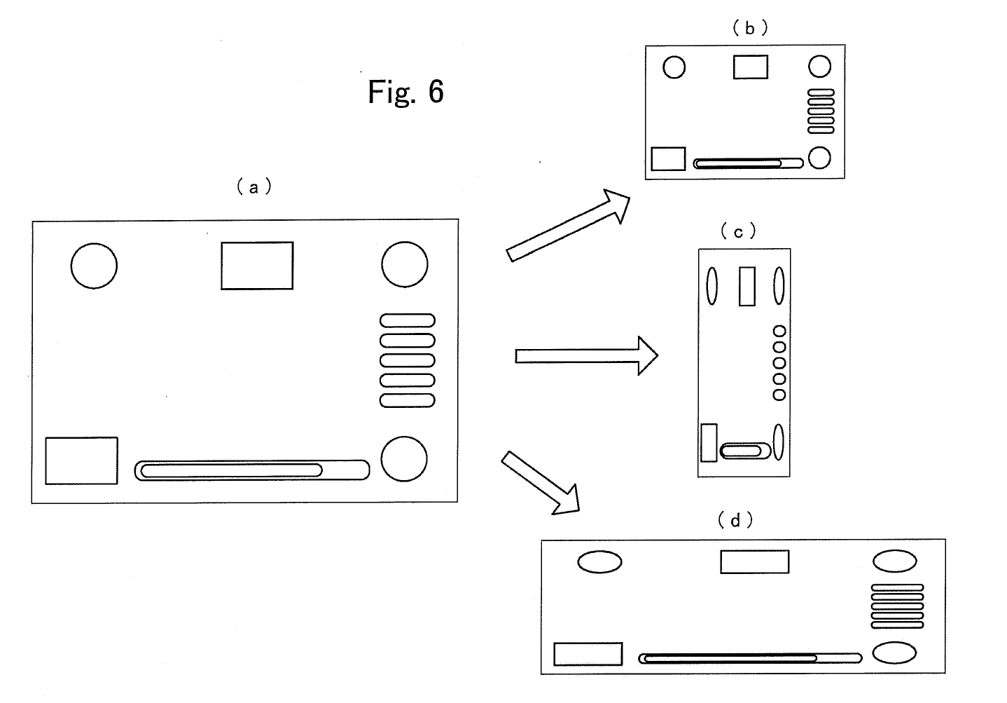

### BEST MODE FOR CARRYING OUT THE INVENTION

(Configuration of 3D Game System)

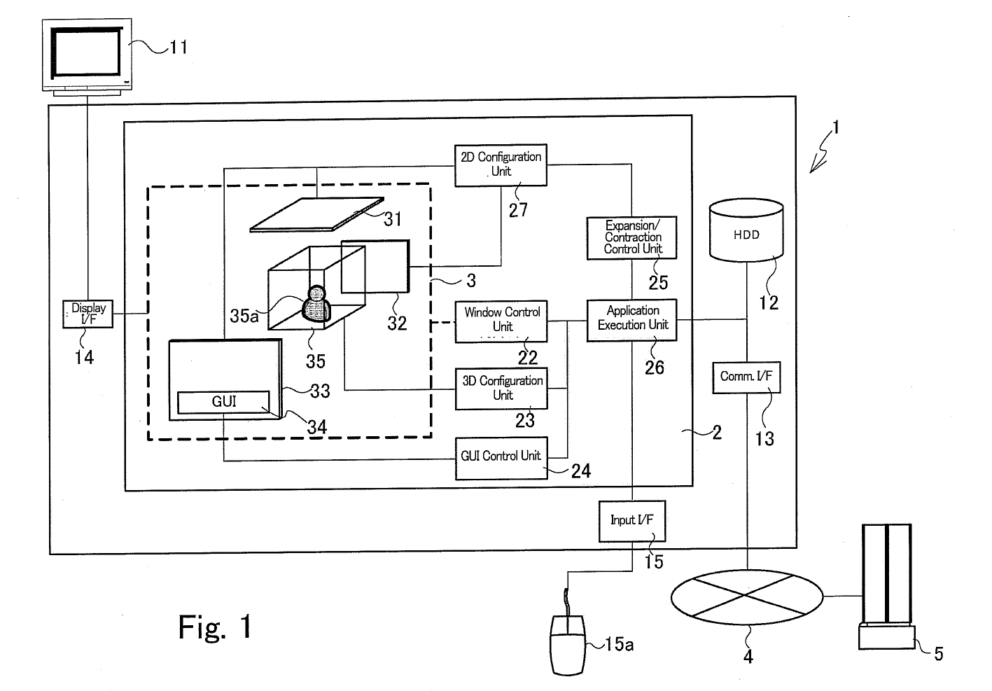

An embodiment of the present invention will be explained with reference to the accompanying drawings. FIG. 1 is a block diagram which shows the configuration of the 3D game system in accordance with the present embodiment. Incidentally, the example of the present embodiment is described in the case where golf game software is run on a personal computer 1. Also, while the present invention is applied to the golf game software in the case of the present embodiment, the present invention is not limited thereto, but also applied to, for example, sports games such as a tennis game and a baseball game, role-playing games including 3D scenes, and any other software displaying three-dimensional images.

The 3D game device in accordance with the present embodiment is implemented with the personal computer 1 in which golf game software is run. More specifically speaking, as shown in FIG. 1, this personal computer 1 comprises a CPU 2 for performing arithmetic operations, a storage device 12 such as a hard disk for storing data and programs, a communication interface (I/F) 13 for accessing a communication network 4 such as the Internet, a display interface (I/F) 14 for connecting a display device such as a display 11, and an input interface (I/F) 15 for connecting input devices 15a such as a mouse, a keyboard and a controller.

Incidentally, the personal computer 1 of the present embodiment is capable of accessing a game server 5 through the communication network 4, and communicating with the game devices used by other users through this game server 5 such that a number of users can participate in the same game through the game server 5.

In other words, when playing the online game through this communication network 4, the respective entry players share the information of the entry players (the properties of characters to be used, the properties of items such as own clubs, or other information necessary for playing the game) and the information necessary for demonstration as delivered to the terminals of the respective entry players through the game server 5. On the other hand, the information on the 3D shapes of courses, the design of each character, texture and so forth relating to the presentation of a virtual space is installed in the terminal of each user in advance. The processes of three-dimensional and two-dimensional images are performed on the user terminal side, such that the condition of each player and the progress of the game are synchronized and reflected to the user terminal on a real time base. Incidentally, during playing the game, while providing enhanced demonstration, making the scene alive and enabling the entry players to deliver and share information as talking theiramong at certain intervals, the information is shared in a simple manner during inputting a shot condition, and the input condition after finishing the input operation is completely shared through the server 5.

A variety of modules are built by driving the CPU 2 to run a golf game software. In the context of this document, the term “module” is intended to encompass any function unit capable of performing necessary operation, as implemented with hardware such as a device or an apparatus, software capable of performing the functionality of the hardware, or any combination thereof. More specifically described, the CPU 2 runs the golf game software to build a window control unit 22, a 3D configuration unit 23, a GUI control unit, an expansion/contraction control unit 25, an application execution unit 26 and a 2D configuration unit 27.

The application execution unit 26 is a module for running the golf game software to proceed with the golf game by making use of objects which are arranged in a 3D virtual space 3. More specifically speaking, the application execution unit 26 performs the progress management of the game in accordance with the rules of golf (OB is counted as one penalty stroke; when there are a plurality of players, each player make a shot in a controlled order; and so forth), the score management on the basis of progress of the golf game, and the arithmetic operation necessary for ballistic simulation of the projectile in the virtual space by calculating the condition of a ball which is struck in accordance with stroke analysis on the basis of the ability parameters of the character and the properties of items as used, such as a golf club.

Incidentally, while a virtual 3D space 35 is constructed as a three-dimensional representation to make alive the scene and the like in the case of this golf game program, since the display device the user views is two-dimensional, the interface is provided for helping the user to spatially recognize the space by automatically performing the camera work which is moved in the vertical plane along the shooting direction, representing this plane in association with a power gauge, and so forth.

Then, the golf game program receives the user operation through the input interface 15, proceeds with the game in accordance with the condition (operation data) acquired in response to the user operation, generates display information items (3D polygons and so forth), displays the windows 31 to 33 as two-dimensional planes, and outputs sound associated with the display.

The window control unit 22 is a module for controlling the windows 31 to 33 displayed in the screen. Specifically speaking, while a virtual camera is provided for setting the field-of-view range in the 3D space 3, the objects imaged by the virtual camera are displayed in the respective windows 31 to 33 as two-dimensional planes. Meanwhile, in the case of the present embodiment, the window 33 is a main window showing a shot over the player in a full view of a golf course. The main window includes the GUI 34. Also, the window 32 is a jump window in which is imaged the location near the position a ball reaches, and the window 31 is a top window in which is imaged the golf course as a bird's-eye view.

The 3D configuration unit 23 is a module for virtually constructing the 3D space 3, and controlling the position coordinates of the objects located in the 3D space 35 in this virtual 3D space 3. The 2D configuration unit 27 is a module for two-dimensionally displaying the 3D space 3 in the windows 31 to 33 in accordance with the field-of-view range of each of the windows 31 to 33 on the basis of the type, area and shape of each window.

The GUI control unit 24 is a module for controlling the graphic user interface (GUI) 34 which is located in the windows 31 to 33 (mainly in the main window 33 in the case of the present embodiment) for displaying information about the game and enabling the user to perform operation. In the case of the present embodiment, the golf game proceeds in response to the operation of an object displayed in the display 11 through the GUI 34 by the use of the input device 15a.

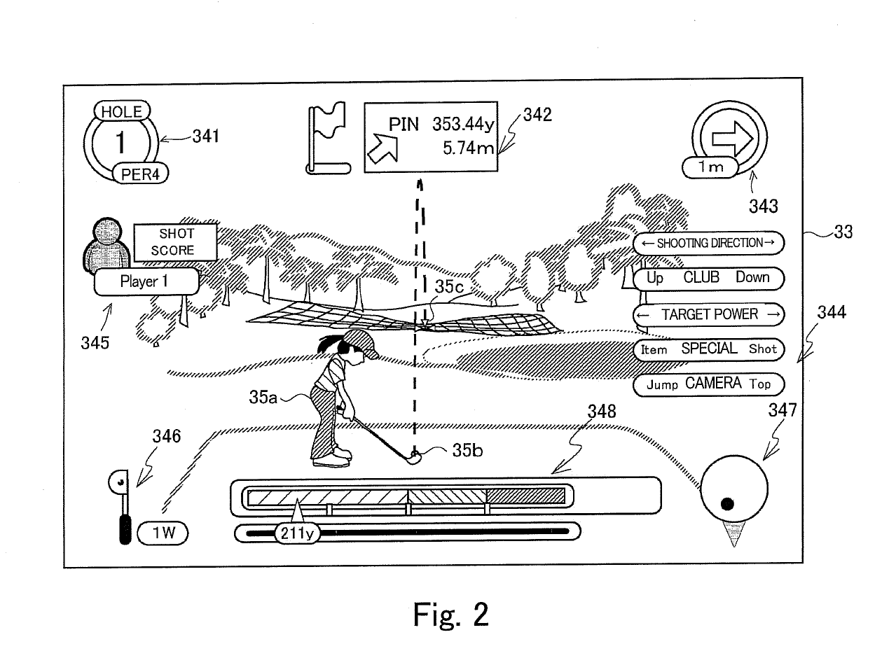

The GUI 34 comprises graphics mainly displayed in the main window 33, for example, an icon 341 indicative of the progress of the golf game (hole number and par type), an icon 342 indicative of the distance and direction to the pin, an icon 343 indicative of how the wind blows, icons 344 indicative of the status of the player (shooting direction, club, target power, camera position, and the like), icons 345 indicative of the name and score of the player, an icon 346 indicative of the golf club the player has selected, an icon 347 indicative of the strike point of the ball, an icon 348 which is operated when striking the ball, and so forth, as illustrated in FIG. 2.

In the case of the present embodiment, as one of the user operations which are input through this input device 15a, stroke data is input when the player 35a strikes a golf ball 35b. This stroke data is input on the basis of operations on the GUI 34 (mainly, the icon 348), and thereby the position coordinates of the golf ball 35b which is one of the objects are changed in the 3D space 3.

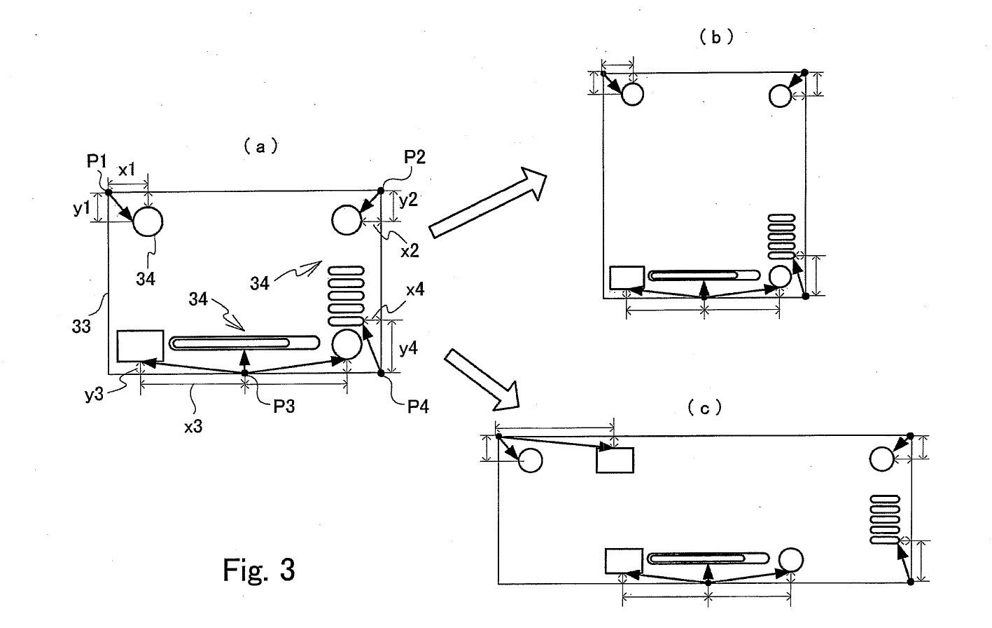

The expansion/contraction control unit 25 is a module for changing the areas and shapes of the windows 31 to 33 on the basis of the operation through the input device 15a. More specifically speaking, as illustrated in FIG. 3(a), the GUI 34 (341 to 348) in each window (the window 33 in this case) is rearranged by determining the positions on the basis of the distance from base points P1 to P4 unique to each window as relative position coordinates ((x1, y1), (x2, y2), (x3, y3) and (x4, y4)). The expansion/contraction control unit 25 calculates the position coordinates of the base points P1 to P3, and expands and/or contracts the relative position coordinates ((x1, y1), (x2, y2), (x3, y3) and (x4, y4)) in accordance with the change of the window in shape as illustrated in FIGS. 3(a) and 3(b). The GUI 34 (341 to 348) is expanded and/or contracted in accordance with the expansion/contraction of the relative position coordinates ((x1, y1), (x2, y2), (x3, y3) and (x4, y4)) by determining the distances and angles relative to the base points P1 to P3 of the icons 341 to 348, and expanding and/or contracting the icons 341 to 348 in correspondence with the scale of the relative position coordinates ((x1, y1), (x2, y2), (x3, y3) and (x4, y4)).

Incidentally, the base points P1 to P4 of the present embodiment are displayed in position coordinates at the scale corresponding to the smaller one of the expansion ratios in the vertical and horizontal directions of the window. Upper and lower limits are set for the ratio of expansion and contraction of the GUI 34, which is expanded and/or contracted between the upper and lower limits.

(Display Method of 3D Game)

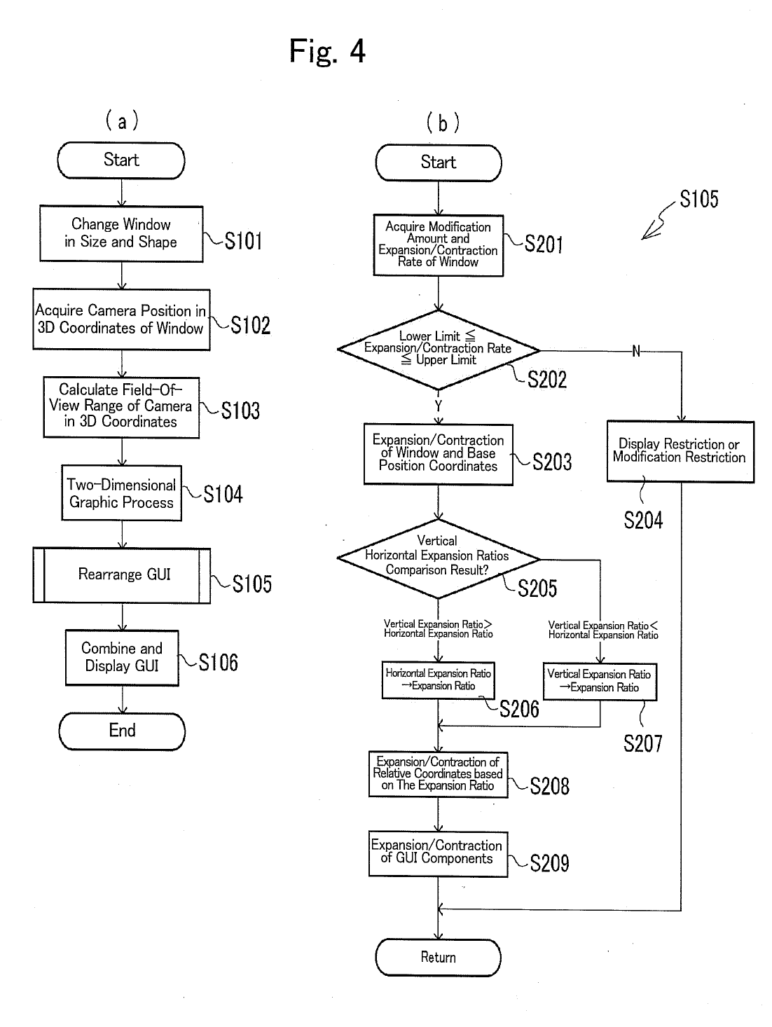

The 3D game display method in accordance with the present invention can be implemented by operating the 3D game system having the structure as described above. FIGS. 4(a) and (b) are flow charts for showing the operation of the 3D game system in accordance with the present embodiment when displaying windows.

First, it is assumed that operation is performed to change a window (the window 33 in this case) in size and/or shape by the use of the input device 15a through the application execution unit 26 and the window control unit 22 in step S101.

In response to this operation, the 3D configuration unit 23 acquires the camera position in the virtual three-dimensional coordinate system corresponding to the window 33 to be handled in step S102, and calculates the position coordinates of the objects located in the field-of-view range of the camera in step S103. The calculation result by the 3D configuration unit 23 is transmitted to the 2D configuration unit 27, which performs two-dimensional graphic processes of the 3D space 35 in step S104. When performing the two-dimensional graphic processes, in step S105, the expansion/contraction control unit 25 changes the window 33 to be handled in area and shape through the window control unit 22, and performs the process of rearranging the GUI 34.

In this step S105, the expansion/contraction control unit 25 acquires the modification amount and expansion/contraction rate of the window 33 to be handled as shown in FIG. 4(b) in step S201, and determines whether or not the expansion/contraction rate is within the range between the upper and lower limits in step S202. If the expansion/contraction rate is beyond the range (i.e., the “No” branch from step S202), display restriction and/or modification restriction is performed in step S204. For example, as the display restriction when displayed in a reduced size, the GUI is simplified by omitting part of the GUI, restricting the display of an omissible icon(s) in accordance with the levels of importance. Also, as the modification restriction, the contraction of the window 33 is directly restricted when operation is made to display in a reduced size, and the expansion of the window 33 is directly restricted when operation is made to display in an increased size.

If the expansion/contraction rate is within the range in step S202, the expansion ratios in the vertical and horizontal directions are compared, and the smaller expansion ratio is determined as a reference expansion ratio in steps S205 to S207. Then, the position coordinates of the base points P1 to P3 in the window 33 are calculated, as well as the expansion ratios of the relative position coordinates ((x1, y1), (x2, y2) and (x3, y3), by the use of this reference expansion ratio. In addition to this, the components of the GUI 34 are expanded/contracted.

The 2D configuration unit 27 combines the 3D space 35 which is two-dimensionally drawn and the GUI 34 which is rearranged and expanded/contracted, and displays the combination in step S106.

(Display Program)

The system and method as described above in accordance with the present embodiment can be performed in a computer by running an input program described in a predetermined language. Namely, the system having the functionality as described above can easily be implemented by installing the program in a user terminal, a personal computer such as a Web server, an IC chip and so forth, and running the program on a CPU. This program can be distributed, for example, through a communication line, or as a package application which can be run on a stand-alone computer.

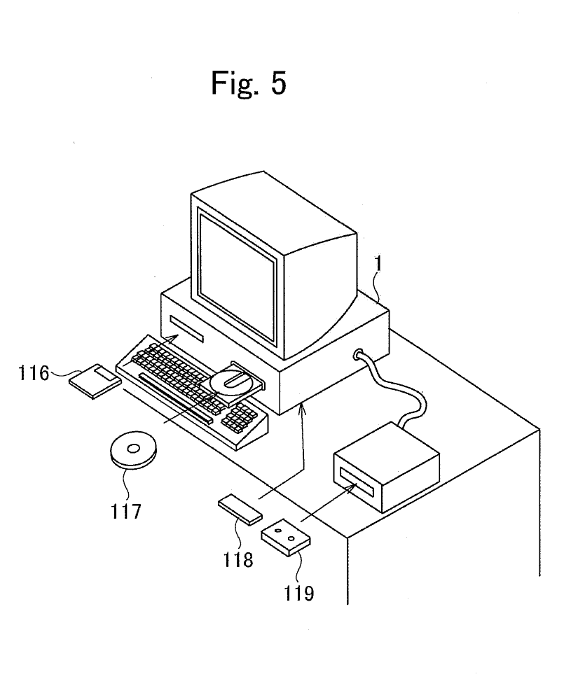

This program may be stored in a medium 116 to 119 which can be read by the personal computer 1 as shown in FIG. 5. More specifically speaking, as shown in the same figure, the program may be stored in a variety of recording mediums, for example, a magnetic recording medium such as a flexible disk 116 or a cassette tape 119, or an optical disc such as a CD-ROM or DVD-ROM 117, a RAM card 118 and so forth. The present embodiment is characterized in that a link can be included in content recorded on the CD-ROM or DVD-ROM 117 which cannot be altered.

Then, in accordance with the computer readable medium in which the program is stored, the system and method as described above can be implemented with a general purpose computer or a dedicated computer, so that the program can be easily maintained, transported and installed.

(Actions/Effects)

As has been explained above, in accordance with the present embodiment, it is possible to view the virtual 3D space 35 from arbitrary angles in various ways through the multiple windows 31 to 34, rearrange the GUI 34 in the window 33 on the basis of the relative distances and angles as seen from the base points P1 to P4 which are displaced in synchronization with the expansion/contraction of the window 33, and thereby prevent deformation and excessive expansion/contraction due to the expansion/contraction of the window 33.

### INDUSTRIAL APPLICABILITY

As has been described above, in accordance with the present invention, game content can be displayed from many directions in multiple windows when a game such as a golf game is proceeding by operations of a player, a ball and other objects arranged in the virtual 3D space through the GUI, and thereby it is possible to maintain the operability of the GUI and the balance between the display of game content and the GUI.

What is claimed is:

1. A 3D game display system for displaying the progress of a game program in a two-dimensional screen with objects arranged in a virtual 3D space, the display system comprising:
a 3D configuration unit configured to virtually construct the 3D space, and control the position coordinates of the objects;
a window control unit configured to control a window displayed on the screen;
a 2D configuration unit configured to two-dimensionally display the 3D space in the window in accordance with the field-of-view range on the basis of the type, area and shape of the window;
a user interface control unit configured to control a graphic user interface which is arranged in the window for use in displaying information about the game and inputting operation to the game;
an input interface used for performing operation of the graphic user interface; and
an expansion/contraction control unit configured to change the window in area or shape on the basis of the operation input through the input interface,
wherein the graphic user interface is displayed on the basis of a position and scale in relative coordinates to a base point which is unique to the window, and
the expansion/contraction control unit calculates the position of the base point and the scale of the relative coordinates in accordance with the shape of the window.

2. The 3D game display system as claimed in claim 1 wherein the base point is displayed in position coordinates at the scale corresponding to the smaller one of the expansion ratios in the vertical and horizontal directions of the window.

3. The 3D game display system as claimed in claim 1 wherein upper and lower limits are set for the ratio of expansion and contraction of the graphic user interface, and
the graphic user interface is expanded and/or contracted between the upper and lower limits in accordance with the change of the window in area.

4. A 3D game display method for displaying the progress of a game program in a two-dimensional screen with objects arranged in a virtual 3D space, the display method comprising:
constructing the 3D space virtually, and controlling the position coordinates of the objects;
displaying the 3D space two-dimensionally in the window in accordance with the field-of-view range on the basis of the type, area and shape of the window in the two-dimensional screen by the use of a 2D configuration unit, and controlling a graphic user interface which is arranged in the window for use in displaying information about the game and inputting operation to the game by the use of a user interface control unit; and
receiving operation of the graphic user interface through an input interface, and changing the window in area or shape by the use of an expansion/contraction control unit on the basis of the operation input through the input interface,
wherein the graphic user interface is displayed on the basis of the position and scale determined in accordance with the distance in relative coordinates from the base point which is unique to the window, and
the expansion/contraction control unit calculates the position of the base point and the scale of the relative coordinates in accordance with the shape of the window.

5. The 3D game display method as claimed in claim 4 wherein the base point is displayed in position coordinates at the scale corresponding to the smaller one of the expansion ratios in the vertical and horizontal directions of the window.

6. The 3D game display method as claimed in claim 4 wherein upper and lower limits are set for the ratio of expansion and contraction of the graphic user interface, and
the graphic user interface is expanded and/or contracted between the upper and lower limits in accordance with the change of the window in area.

7. A 3D game display program for displaying the progress of a game program in a two-dimensional screen with objects arranged in a virtual 3D space, the display program causing a computer to perform
a step for virtually constructing the 3D space, and controlling the position coordinates of the objects;
a step for two-dimensionally displaying the 3D space in the window in accordance with the field-of-view range on the basis of the type, area and shape of the window in the two-dimensional screen by the use of a 2D configuration unit, and controlling a graphic user interface which is arranged in the window for use in displaying information about the game and inputting operation to the game by the use of a user interface control unit; and
a step for receiving operation of the graphic user interface through an input interface, and changing the window in area or shape by the use of an expansion/contraction control unit on the basis of the operation input through the input interface,
wherein, in the step for two-dimensionally displaying the 3D space, the graphic user interface is displayed on the basis of the position and scale determined in accordance with the distance and angle relative to a base point in coordinates which is unique to the window, and
in the step for receiving operation of the graphic user interface, the expansion/contraction control unit calculates the position coordinates of the base point in accordance with the shape of the window.

8. The 3D game display program as claimed in claim 7 wherein the base point is displayed in position coordinates at the scale corresponding to the smaller one of the expansion ratios in the vertical and horizontal directions of the window.

9. The 3D game display program as claimed in claim 7 wherein upper and lower limits are set for the ratio of expansion and contraction of the graphic user interface, and
the graphic user interface is expanded and/or contracted between the upper and lower limits in accordance with the change of window in area.
